(19) United States
(12) Patent Application Publication
(10) Pub. No.: US 2023/0114314 A1
(43) Pub. Date: Apr. 13, 2023

(54) SYSTEM, METHOD, AND DEVICE FOR AUTOMATING BILLING AND PAYMENTS

(71) Applicant: En-Powered Inc., kitchener (CA)

(72) Inventors: Tomas Nathan van Stee, Kitchener (CA); Michael Grant Kirkup, Waterloo (CA)

(21) Appl. No.: 17/965,353

(22) Filed: Oct. 13, 2022

Related U.S. Application Data
(60) Provisional application No. 63/255,224, filed on Oct. 13, 2021.

(51) Int. Cl. G06Q 20/14; G06Q 30/04

(52) U.S. Cl. CPC G06Q 20/14; G06Q 30/04

(57) ABSTRACT

Provided are systems, methods, and devices for automating billing and payments. The system includes a first participant for providing energy to a third participant, a device of the first participant for sending a bill to a device of the second participant, the device of the second participant for receiving the bill, modifying the bill according to energy-related resource billing data provided by a device of a fourth participant by adding the fourth participant to the bill, and sending the modified bill to a device of the third participant, the third participant receiving the energy from the first participant and energy-related resource from the fourth participant, the device of the third participant paying the modified bill, the fourth participant for providing the energy-related resource to the third participant, and the device of the fourth participant for sending the energy-related resource billing data for the energy-related resource to the device of the second participant.

### TECHNICAL FIELD

The following relates generally to electronic billing and payments, and more particularly to systems, methods, and devices for automating bills and payments.

### INTRODUCTION

Complicated legal regimes often govern the contractual relationships between consumers of resources such as electricity and the utilities or retailers that provide such resources. Because of the complicated legal regimes in effect, there may exist a variety of simplifying means or efficiencies otherwise ordinarily available to one or more parties to such contractual relationships that cannot easily be implemented in the present context. Inefficiencies may abound to the detriment of, for example, the consumer.

The consumer may wish to receive multiple resources, such as electricity and an energy-related resource (e.g., lighting fixtures, HVAC automation system, generator, battery, software applications, etc.) from multiple sources without having to engage in complicated accounting procedures. Such a consumer may desire a single bill reflecting all such sources that may be satisfied with a single payment to a single account. One means of implementing the foregoing is through modification of a bill prepared by one such source to in order to reflect all such sources. The participant or device so modifying the bill may then be responsible for collecting and disbursing payment.

Because of the legally protected nature of utilities and energy retailers, however, simplification and/or modification of a bill involving utilities and/or energy retailers has historically been difficult to implement and cost-prohibitive to offer.

Therefore, it is desirable to practice systems, methods, and devices for centralizing and simplifying by automating billing and payments. Such systems, methods, and devices may be implemented through computer systems so that, where existing bill-paying systems, methods, and devices were computer-implemented, the computers on which the present disclosure is implemented is thereby improved as to functionality, further effecting a physical result and change.

### SUMMARY

Provided is a system for automating billing and payments. The system includes an energy generation device of a first participant for providing energy to a third participant, a device of the first participant for sending a bill to a device of a second participant for the energy provided by the energy generation device to the third participant, the device of the second participant for receiving the bill from the device of the first participant, modifying the bill according to energy-related resource billing data provided by a device of a fourth participant by adding the fourth participant to the bill as a second payee, and sending the modified bill to a device of the third participant, the third participant for receiving the energy from the first participant and an energy-related resource from the fourth participant, the device of the third participant for receiving the modified bill from the device of the second participant and paying the modified bill, the fourth participant for providing the energy-related resource to the third participant, and the device of the fourth participant for sending the energy-related resource billing data for the energy-related resource to the device of the second participant.

Provided is a method for automating billing and payments. The method includes providing energy, preparing a bill for the energy, a fourth participant providing an energy-related resource, preparing energy-related resource billing data for the energy-related resource, the energy-related resource billing data comprising a second payee, modifying the bill according to the energy-related resource billing data by adding the fourth participant to the bill as the second payee, sending the modified bill, and paying the modified bill.

Provided is a device of a second participant for automating billing and payments. The device of the second participant includes a receiving module for receiving a bill from a device of a first participant and energy-related resource billing data from a device of a fourth participant, the bill corresponding to energy provided by the first participant, and the energy-related resource billing data corresponding to an energy-related resource provided by the fourth participant, a modifying module for modifying the bill according to the energy-related resource billing data by adding the fourth participant to the bill as a second payee, and a collection module for sending the modified bill to a device of a third participant for payment.

Provided is a system for automating billing and payments. The system includes a first participant for providing a first resource to a third participant, a device of the first participant for sending a bill for the first resource to a device of a second participant, the device of the second participant for receiving the bill from the device of the first participant, modifying the bill according to first billing data provided by a device of a fourth participant by adding the fourth participant to the bill as a second payee, and sending the modified bill to a device of the third participant, the third participant for receiving the first resource from the first participant and a second resource from the fourth participant, the device of the third participant for receiving the modified bill from the device of the second participant, the fourth participant for providing the second resource to the third participant, and the device of the fourth participant for sending the first billing data for the second resource to the device of the second participant.

Provided is a method for automating billing and payments. The method includes providing a first resource, preparing a bill for the first resource, a fourth participant providing a second resource, preparing first billing data for the second resource, the first billing data comprising a second payee, modifying the bill according to the first billing data by adding the fourth participant to the bill as the second payee, and sending the modified bill.

Provided is a device of a second participant for automating billing and payments The device of the second participant includes receiving module for receiving a bill from a device of a first participant and first billing data from a device of a fourth participant, the bill corresponding to a first resource provided by the first participant, and the first billing data corresponding to a second resource provided by the fourth participant, a modifying module for modifying the bill according to the first billing data by adding the fourth participant to the bill as a second payee, and a collection module for sending the modified bill to a device of a third participant.

Provided is a method for soft enrolling a third participant into a system for automating billing and payments. The method includes logging into an internal portal of a second participant, travelling to a company account page, reviewing an empty state payments card and button that says “Enroll Utility Account”, indicating to enroll a utility account of the third participant by clicking the button, filling in utility account information, a region, and a utility in a form, clicking either a “Submit” button or a “Cancel” button, if clicking the “Cancel” button, ending the method, if clicking the “Submit” button, uploading the information and determining support of the second participant for the region and utility, if the region and the utility are not supported, ending the method, if the region and the utility are supported, populating a payments card associated with the third participant, extracting information from a bill of the third participant to fill out an EDI (electronic data interchange) form of the sixth participant, if the bill does not provide enough information, requesting the third participant to submit a different bill, if the bill does provide enough information, sending the EDI form to the sixth participant for processing by clicking “Submit”, and if the third participant meets the minimum utility usage, soft enrollment succeeds.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a billing modification system for modifying a bill to include an additional payee, in accordance with an embodiment;

FIG. 2 is a block diagram of a computing device of the present disclosure, according to an embodiment;

FIG. 3 is a block diagram of a distribution system for distributing the resources for which first billing data is generated and modified within the system of FIG. 1, according to an embodiment;

FIG. 4 is a block diagram of a computer system for implementing the systems of FIGS. 1 and 3, according to an embodiment;

FIG. 5 is a flow diagram of a method for bill modification, according to an embodiment;

FIG. 6 is a block diagram showing a network of funds flowing during or after operation of the systems of FIGS. 1 and 3, in accordance with an embodiment;

FIG. 7 is a flow diagram of a method for soft enrollment of a third participant of the system of FIG. 1, in accordance with an embodiment;

FIG. 8 is a block diagram of a system for automated payments and billing, in accordance with an embodiment;

FIG. 9 is an exemplary bill as provided to the system of FIG. 1, in accordance with an embodiment;

FIG. 10 is an exemplary bill as provided by the system of FIG. 1, in accordance with an embodiment;

FIG. 11 is an exemplary bill as provided by the system of FIG. 1, in accordance with an embodiment; and

FIG. 12 is an exemplary account statement, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistant, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

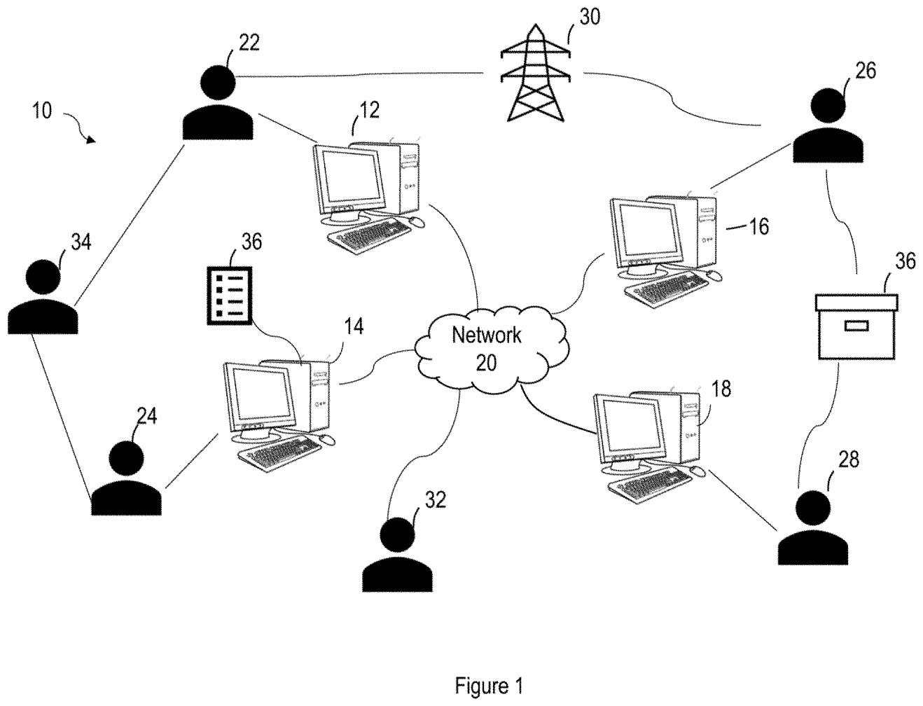

Referring now to FIG. 1, shown therein is a block diagram illustrating a billing modification system 10, in accordance with an embodiment. The system 10 includes a first participant device 12 for communicating with a first participant 22, a second participant device 14 for communicating with a second participant 24, a third participant device 16 for communicating with a third participant 26, and a fourth participant device 18 for communicating with a fourth participant 28.

The devices 12, 14, 16, 18 may be a server computer, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

In the description that follows, devices 12, 14, 16, 18 are described performing certain acts. It will be appreciated that any one or more of these devices may perform an act automatically or in response to an interaction by a user of that device (such as the first participant 22, the second participant 24, the third participant 26, and the fourth participant 28, respectively). That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 16, 18 may send information to the second participant device 14. For example, the second participant 24 using the second participant device 14 may manipulate one or more input devices (e.g., a mouse and a keyboard) to interact with a user interface displayed on a display of the second participant device 14. Generally, the devices 12, 14, 16, 18 may receive a user interface from the network 20 (e.g., in the form of a webpage). Alternatively or in addition, a user interface may be stored locally at a device (e.g., a cache of a webpage or a mobile application).

In response to receiving information, the second participant device 14 may store the information in a storage database. The storage may correspond with secondary storage of the second participant device 14. Generally, the storage database may be any suitable storage device such as a hard disk drive, a solid state drive, a memory card, or a disk (e.g. CD, DVD, or Blu-ray etc.). Also, the storage database may be locally connected with the second participant device 14. In some cases, storage database may be located remotely from the second participant device 14 and accessible to the second participant device 14 across a network for example. In some cases, the storage database may comprise one or more storage devices located at a networked cloud storage provider.

The first participant device 12 may be associated with a first participant account. Similarly, the second participant device 14 may be associated with a second participant account. Similarly, the third participant device 16 may be associated with a third participant account. Similarly, the fourth participant device 18 may be associated with a fourth participant account. Any suitable mechanism for associating a device with an account is expressly contemplated. In some cases, a device 12, 14, 16, 18 may be associated with an account by sending credentials (e.g., a cookie, login, password) to the respective device. The respective device may verify the credentials (e.g., determine that the received password matches a password associated with the account). If a device 12, 14, 16, 18 is associated with an account, the other devices may consider further acts by that device 12, 14, 16, 18 to be associated with that account.

The first participant device 12 sends a bill to the second participant device 14 for a first resource provided by the first participant 22 to the third participant 26.

The first participant device 12 is provided by the first participant 22. The first participant 22 may be an energy company that physically generates energy (e.g., electricity) sold to customers. The first resource may be electricity. The first resource may be natural gas.

The first participant 22 may be a utility company that offers the energy to customers such as the third participant 26.

The first participant 22 may be an energy retailer with a legally protected status, whose status is not affected by the operation of the system 10.

The second participant device 14 may be a purpose-built machine designed specifically for modifying a bill according to first billing data to generate the modified bill 36. The second participant device 14 may specifically generate the modified bill 36 by adding the fourth participant 28 as a second payee. The second participant device 14 may provide the energy on a modified bill 36. Where the first participant 22 is an energy retailer, a soft enrollment of the third participant 26 in the system 10 may be performed. In soft enrollment, the second participant device 14 determines there are no known issues preventing enrollment of a customer. Soft enrollment may end with the system 10 able to label a given utility account as able or unable to continue with payments.

The first participant device 12 is provided by the first participant 22 which may be a utility, and the second participant 24 assumes the status of an energy retailer. Where the second participant 24 becomes an energy retailer, a hard enrollment of the third participant 26 in the system 10 may be performed. In hard enrollment, the second participant 24 sends a formal request to become the registered energy retailer for the third participant 26 by sending an enrollment request to an EDI (electronic data interchange) vendor 34. The second participant 24 may not effect hard enrollment until ready to place a charge on the modified bill 36.

Where the second participant 24 does not become an energy retailer, the second participant device 14 may not be able to change a total amount of funds due for legal compliance. The second participant device 14 may calculate what the third participant device 16 would otherwise have paid the first participant device 12 for energy and may charge that amount plus a fee. The modified bill 36 may display an amount of money saved by the third participant device 16. The amount of money saved may be provided in terms of KWh. The savings may be validated, for example, by measuring usage before and after the energy-related resource has been installed to determine how much money was saved by the third participant 26. The measurements may be conducted using submeters for a specific area of a facility to isolate a piece of equipment. Such measurements may be conducted by a certified measurement and verification professional. The modified bill 36 may display costs charged by the second participant device 14 as second participant fees in addition to the costs of the first resource and the second resource. The second participant fees may include the costs of the second resource. The second participant fees may include the costs of the first resource. The savings accrued the third participant device 16 may be accessible on the modified bill 36 via URL, link, etc.

The system 10 further includes the second participant device 14 for receiving and modifying the bill to generate the modified bill 36. The second participant device 14 receives the bill from the first participant device 12. The second participant device 14 modifies the bill according to first billing data provided by a fourth participant device 18. The fourth participant device 18 corresponds to the fourth participant 28, which provides a second resource to the third participant 26. The second participant device 14 generates the modified bill 36 by adding the fourth participant 28 to the bill as a second payee. The second participant device 14 further sends the modified bill 36 to the third participant device 16.

The first billing data may be energy-related resource billing data, and the second resource provided by the fourth participant 28 may be an energy-related resource (e.g., hardware such as lighting fixtures, HVAC automation systems, generators, and batteries, or software such as HVAC system applications). The energy-related resource billing data is billing data corresponding to the energy-related resource provided by the fourth participant 28.

Generating the modified bill 36 may further include adding charges and/or rebates to the bill.

The third participant device 16 receives the modified bill 36 from the second participant device 14. The third participant device 16 pays the modified bill 36.

The third participant 26 receives the energy from the first participant 22. The third participant 26 further receives the second resource from the fourth participant 28.

The system 10 may further include an energy generation device 30 of the first participant 22 for providing energy to the third participant 26. The first participant device 12 may send the bill to the second participant device 14 for the energy provided by the energy generation device 30 to the third participant 26.

The system 10 includes a second resource provision device 36 of the fourth participant 28 for providing the second resource to the third participant 26. The fourth participant device 18 may send the first billing data to the second participant device 14 for the second resource provided by the second resource provision device 36 to the third participant 26.

The fourth participant device 18 sends the first billing data for the second resource to the second participant device 14.

The second participant device 14 may directly modify the bill, using EDI as described above in relation to FIG. 1.

EDI serves as a standard for how data is sent. The data is sent to an EDI vendor 34 in order for the EDI vendor 34 to add charges, including a second participant, to the modified bill 36. The system 10 abstracts complexity across all markets so that a developer calling a payment API of the second participant 24 does not need to be aware of peculiarities of individual markets (e.g., Ohio vs New York vs Ontario). The system 10 further supports the ability to add multiple charges to a single electricity bill. The system 10 further supports the ability to add both rebates and charges to a single bill. The system 10 further supports the ability to add both rebates and charges to a single bill (e.g., $1000 per month for the next 50 months). The system 10 further supports the ability to support different amounts of recurring charges and rebates over a period of time. The system 10 further supports the ability to transfer an incoming amount of money to a different participant than one who placed the corresponding charge on the bill.

The second participant device 14 may instruct the EDI vendor 34 to provide EDI services to modify the bill as described above in relation to FIG. 1. The EDI vendor 34 may be understood as a sixth participant 34.

Modifying the bill may take place according to electronic data interchange (EDI). EDI is the exchange of data between businesses and across computers according to technical standards. EDI may be performed through the exchange of CSV files according to the File Transfer Protocol (FTP). For example, a CSV file may be placed in an FTP folder to which the EDI vendor 34 has access.

After the CSV file is placed in the FTP folder, the second participant device 14 may monitor the FTP folder for the EDI vendor 34 to confirm the placement was successful. If unsuccessful, the second participant device 14 may investigate what went wrong. If the failure cannot be fixed remotely, the second participant 24 may manually contact the third participant 26 to resolve the problem.

There may be a tri-party agreement among the first participant 22, the second participant 24, and the EDI vendor 34 to place a charge on an electricity bill prepared by the first participant device 12. Some EDI vendors may have existing template agreements to simplify the process.

Either of the first participant device 12 and the third participant device 16 may make the bill available to the second participant device 14 and/or the EDI vendor 34. Making the bill available may allow the third participant 26 to be enrolled in the system 10.

The tri-party agreement among the first participant 22, the second participant 24, and the EDI vendor 34 may include an agreement to allow the second participant device 14 to instruct the EDI vendor 34 to modify the bill according to the first billing data provided by the fourth participant device 18 by adding the fourth participant 28 to the bill as a payee, an agreement to share revenue of the second participant device 14 received from the third participant device 16 with the first participant device 12, and an agreement to modify a bank account associated with the first participant device 12 into a custodial account.

The first billing data provided by the fourth participant device 18 may correspond to regular payments due on goods leased, sold, or otherwise provided to the third participant 26.

The second participant 24 may arrange financing between the third participant 26 and the fourth participant 28. The financing may include efficiency as a service (EaaS) financing. Financing may include an operating lease, e.g., purchasing an energy-related resource for $100,000 and paying the purchase off in equal installments each month over a period of time, including interest. Financing may also include performance-based contracting, e.g., a customer may receive a percentage of savings (e.g., 20%) and the remaining savings (e.g., 80%) may go towards paying down the financing of the energy-related resource until it is paid off (including interest). Financing may include efficiency as a service (EaaS), wherein the fourth participant device 18 is only paid based on savings generated. Financing may include facilitating agreements with Energy Service Companies (ESCOs).

The system 10 may further include a fifth participant 32 for providing financing, factoring, and/or other financial services in respect of the bill, the first billing data, and or the modified bill 36.

The fifth participant 32 may be a bank or other financial institution.

The modified bill 36 may save the third participant 26 time through simplifying accounting. Advantageously, the third participant 26 may have only one bill to pay for the multiple resources provided. Advantageously, the third participant 26 may be able to read the bill more easily and confirm that savings are coming through by having all charges (e.g., electricity and other charges) in a single place.

All costs for the first resource and the second resource as well as savings caused by operation of the system 10 may appear on the modified bill 36.

Charges on the modified bill 36 may be charged a single time, upon enrollment of the third participant device 16 or otherwise, or on a recurring basis, e.g., a monthly basis, corresponding to the modified bill 36 being sent to the third participant device 16 or otherwise. The charges may be scheduled to continue indefinitely, for a finite period of time, for a finite number of payments, or until a finite amount paid has been reached or exceeded. A start date may be recorded.

A recurring payment may last for a preset time period.

The recurring payment may last until a total amount has been paid to the second payee or other payee.

The recurring payment may last until an agreed condition is met.

A minimum utility usage may be required to enroll the third participant 26 in the system 10. For example, the minimum utility usage may be 200 MWh per month.

The above describes only certain embodiments. In some embodiments the first participant sends data and/or a bill to the second participant who modifies the bill or creates a bill using first participant data and second participant data and then sends a modified bill to the third participant. However, in other embodiments the second participant provides data to the first participant which the first participant uses to modify a bill which is then sent directly to the third participant. Where there is a fourth participant, any and all iterations of the order in which a bill is handled between first/second/fourth participants and the third participant may be contemplated.

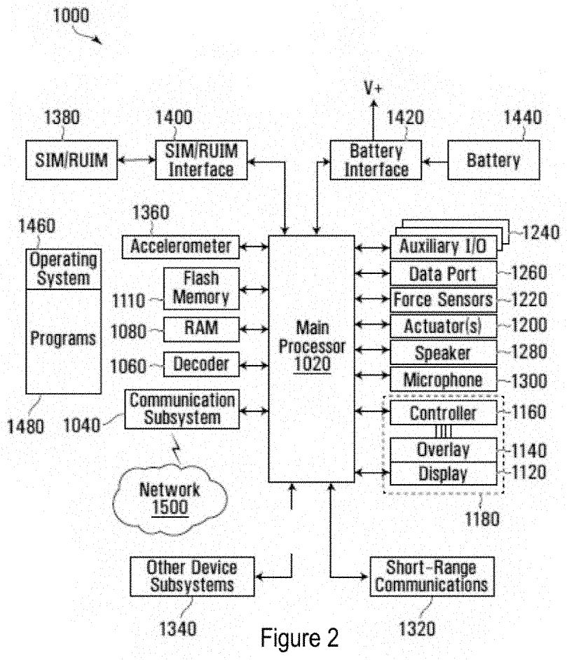

Referring now to FIG. 2, shown therein is a block diagram of a computing device 1000 of the system 10 of FIG. 1, according to an embodiment. The computing device 1000 may be, for example, any one of the devices 12, 14, 16, and/or 18 of FIG. 1.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g., with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 through the electronic controller 1160. Information, such as text, characters, symbols, images, icons, and other items that may be displayed or rendered on a computing device generated by the processor 1020 may be displayed on the touch-sensitive display 1180.

The processor 1020 may also interact with an accelerometer 1360. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1110 or performed using other techniques.

The computing device 1000 also includes an operating system 1460 and software components 1480 that are executed by the processor 1020 and which may be stored in a persistent data storage device such as the flash memory 1110. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

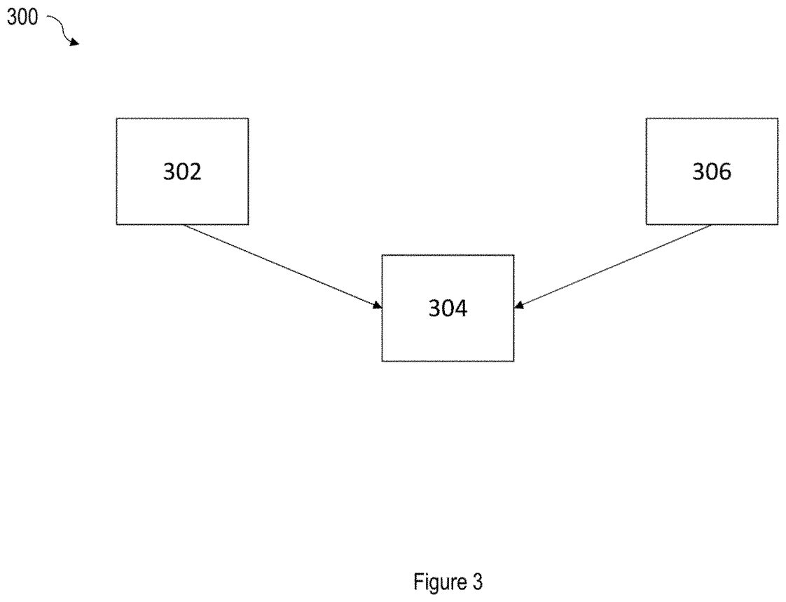

Referring to FIG. 3, shown therein is a block diagram of a distribution system 300 for distributing the resources for which first billing data is generated and modified within the system 10 of FIG. 1, in accordance with an embodiment.

The system 300 includes an energy company 302 for providing energy to a user 304. The energy company 302 may be an energy generating company, a utility, or a retailer. Where the energy company 302 has the legally protected status of retailer, the operation of the system 300 may not alter that status. The energy company 302 may be the first participant 22 of the system 10.

The energy company 302 may be a utility, such as an electricity-providing utility.

The system 300 further includes an energy-related resource company 306 for providing an energy-related resource to the user 304. The energy-related resource company 306 may provide electrical equipment (such as lighting and lighting fixtures) to the user 304. The energy-related resource company 306 may be the fourth participant 28 of the system 10.

The system 300 further includes the user 304 for receiving the energy and the energy-related resource. The user 304 may be the third participant 26 of the system 10.

The billing modification system 10 is used to allow the distribution system 300 to operate by modifying bills so that the user 304 receives only one modified bill representing the bill and the first billing data for both the energy company 302 and the energy-related resource company 306, respectively. The modified bill may be modified to include the energy-related resource company 306 as a payee. The modified bill may allow the user 304 to receive financing for the energy-related resource or otherwise pay off the energy-related resource over time.

Where the first participant 22 is a utility and the second participant 24 is an energy retailer, the second participant device 14 may send a bill directly to the third participant device 16, or the second participant device 14 may have the first participant device 12 send the bill and collect payment from the third participant device 16 on behalf of the second participant device 14.

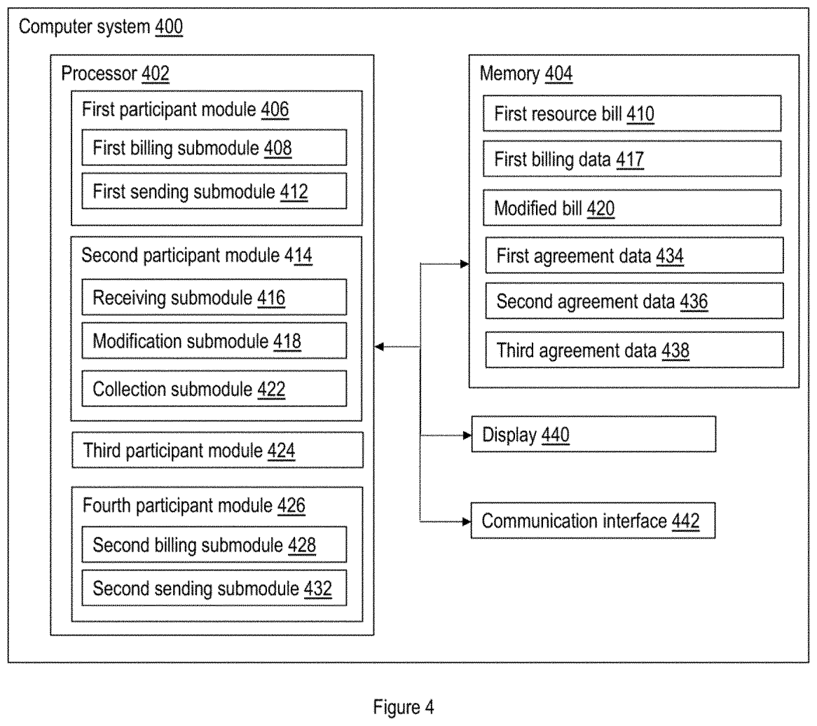

Referring to FIG. 4, shown therein is a block diagram of a computer system 400 for implementing the systems 10, 300 of FIGS. 1, 3 respectively, according to an embodiment. The computer system 400 may be implemented at one or more devices 12, 14, 16, 18 of the system 10 of FIG. 1.

The system 400 includes a processor 402 for running the computer system 400 to implement the systems 10, 300.

The processor 402 includes a first participant module 406 for sending to a second participant module 414 a first resource bill 410 for energy provided by a first participant 22 to a third participant 26.

The first participant module 406 includes a first billing submodule 408 for preparing the first resource bill 410 according to first agreement data 434.

The first participant module 406 further includes a first sending submodule 412 for sending the first resource bill 410 to the second participant module 414.

The processor 402 further includes a second participant module 414 for modifying the first resource bill 410 pursuant to second agreement data 436 according to third agreement data 438.

The second participant module 414 includes a receiving submodule 416 for receiving the first resource bill 410 and receiving first billing data 417 corresponding to a second resource from a fourth participant module 426. The second resource is provided according to third agreement data 438. The receiving submodule 416 receives the first billing data 417 pursuant to the second agreement data 436.

The second participant module 414 further includes a modification submodule 418 for modifying the first resource bill 410 with the first billing data 417 according to the second agreement data 436. Modifying the first resource bill 410 includes adding the fourth participant 28 as a payee. The result of the modification by the modification submodule 418 is stored in the memory 404 as a modified bill 420.

The second participant module 414 further includes a collection submodule 422 for sending the modified bill 420 to a third participant module 424.

The processor 402 further includes the third participant module 424 for receiving the modified bill 420 from the second participant module 414 and paying the modified bill 420.

The processor 402 further includes the fourth participant module 426. The fourth participant module 426 includes a second billing submodule 428 for preparing the first billing data 417 according to the third agreement data 438.

The fourth participant module 426 further includes a second sending submodule 432 for sending the first billing data 417 to the second participant module 414.

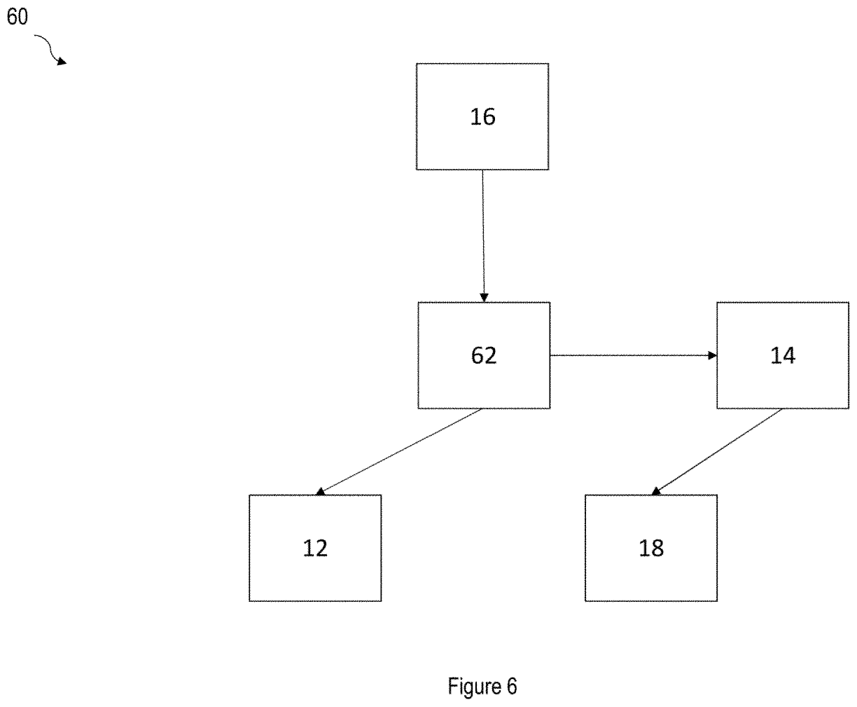

The first agreement data 434 includes an agreement between a first participant 22 and a third participant 26 for the first participant 22 to provide a first resource to the third participant 26. The first agreement data 434 may further include an agreement, where the first participant 22 is a retailer, for the retailer to modify a bank account of record with the utility to be a custodial account 62, as shown in FIG. 6.

The second agreement data 436 includes an agreement (i) by the third participant module 424 and (ii) by the first participant module 406 to allow the second participant module 414 to add the fourth participant 28 as a payee to the modified bill 420 according to the first billing data 417 and (iii) by the second participant module 414 to so add the fourth participant 28 as a payee in the modified bill 420 according to the first billing data 417.

The second agreement data 436 may be agreement data of the tri-party agreement.

The third agreement data 438 includes an agreement between the fourth participant 28 and the third participant 26 for the fourth participant 28 to provide a second resource to the third participant 26.

The system 400 further includes a memory 404 for storing data, including data output from the processor 402. The memory 404 includes the first resource bill 410 prepared according to the first agreement data 434.

The memory 404 further includes the first billing data 417 prepared according to the third agreement data 438. The memory 404 further includes the modified bill 420 prepared according to the second agreement data 436. The memory 404 further includes the first agreement data 434, the second agreement data 436, and the third agreement data 438.

The system 400 further includes the communication interface 442 for communicating with other devices, such as through receiving and sending data through a network connection (e.g., network 20 of FIG. 1). The system 400 may further include a display 440 for displaying various data generated by the computer system 400 in human-readable format.

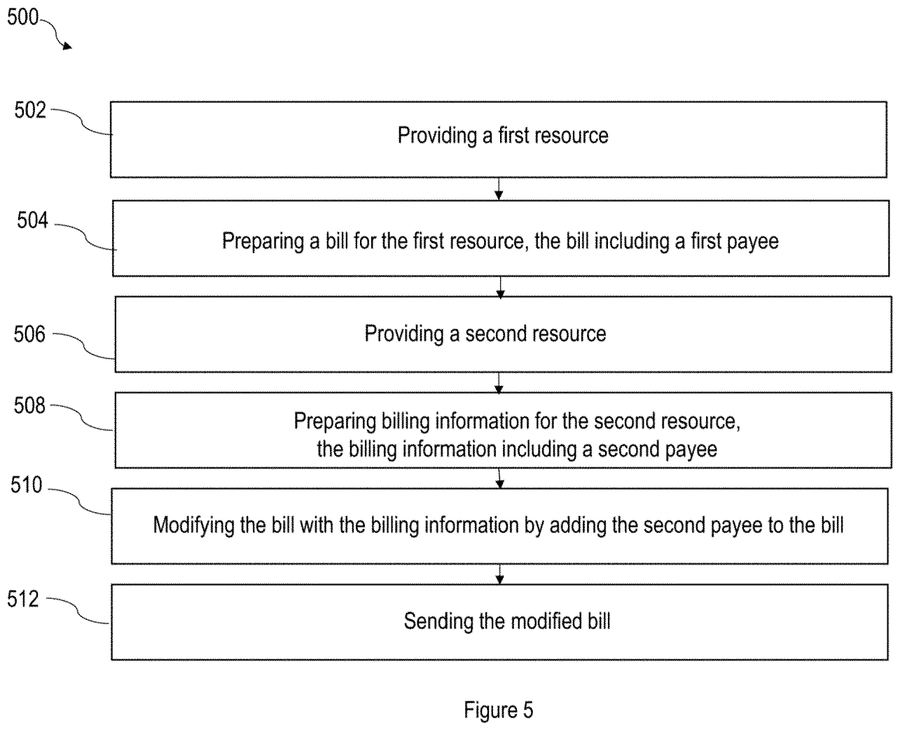

Referring now to FIG. 5, shown therein is a flow diagram of a method 500 for bill modification, according to an embodiment.

At 502, a first participant 22 provides a first resource.

At 504, the first participant device 12 prepares a bill for the first resource, the bill including a first payee. The first payee may be the first participant 22. The first participant 22 may be the energy company 302. The first participant 22 may be an energy generation company. The first participant 22 may be a utility company. The first participant 22 may be an energy retailer. The first resource may be energy (e.g., electricity).

At 506, the fourth participant 28 provides a second resource.

At 508, the fourth participant device 18 prepares first billing data for the second resource, the first billing data including a second payee. The second payee may be the fourth participant 28. The fourth participant 28 may be the energy-related resource company 306. The fourth participant may be a service provider, a software provider, a consultant, a carbon offset provider, etc. The fourth participant 28 may provide electrical equipment (such as lighting and lighting fixtures) to the third participant 26.

At 510, the second participant device 14 modifies the bill with the first billing data by adding the second payee to the bill.

At 512, the modified bill 36 is sent to the third participant device 16 for payment.

Referring now to FIG. 6, shown therein is a block diagram showing a network 60 of funds flowing during or after operation of the systems 10, 300, in accordance with an embodiment.

The network 60 includes a custodial account 62 for receiving funds from the third participant device 16. The third participant device 16 pays into the custodial account 62 after receiving the modified bill 36 as described in FIGS. 1 and 5.

The third participant device 16 may pay a utility company all funds due in respect of the modified bill 36. The utility company may deduct its fees for providing the energy and expenses (e.g., delivery, taxes) and may transmit the remaining funds to the custodial account 62.

The custodial account 62 disburses funds according to the modified bill 36. In the network 60, the first participant device 12 receives disbursed funds from the custodial account 62 to pay for the energy provided the user 304 by the energy company 302.

The fourth participant device 18 receives disbursed funds from the custodial account 62 to pay for the energy-related resource provided the user 304 by the energy-related resource company 306.

The custodial account 62 further disburses funds to the second participant device 14 for implementing the systems, methods, and devices of the present invention. The second participant device 14 disburses funds to the fourth participant device 18 to pay for the energy-related resource provided the user 304 by the energy-related resource company 306. Second participant fees are calculated and taken as the second participant device 14 disburses funds to the fourth participant device 18.

Because the modified bill 36 has been modified according to the first agreement data 434, the second agreement data 436, and the third agreement data 438, the custodial account 62 may be further understood as disbursing the funds according to the first agreement data 434, the second agreement data 436, and the third agreement data 438.

The custodial account 62 may be understood as disbursing funds to the first participant device 12 according to the first agreement, to the second participant device 14 according to the second agreement, and to the fourth participant device 18 according to the third agreement.

The custodial account 62 may further disburse funds to a device of the fifth participant (not shown).

The custodial account 62 may further disburse funds to a device of the sixth participant (not shown).

The custodial account 62 may transfer the second participant fees to the second participant device 14 and leave a portion of the funds in the custodial account 62 as revenue sharing funds for the first participant device 12.

The transfer of funds to the utility providing energy to the third participant 26 may occur at a different frequency to the third participant device 16 paying the modified bill 36. For example, the transfer of funds to the utility may occur weekly, while the third participant device 16 paying the modified bill may occur monthly.

From the perspective of any of the first participant 22 (such as the energy company 302), the first participant device 12, the second participant 24, the second participant device 14, the fourth participant 28 (such as the energy-related resource company 32), the fourth participant device 18, the fifth participant 32, the fifth participant device, the sixth participant device, and/or the sixth participant 34 it may appear that the third participant device 16 is disbursing funds directly to each and/or any of the first participant 22 (such as the energy company 302), the first participant device 12, the fourth participant 28 (such as the energy-related resource company 32), the fourth participant device 18, the fifth participant 32, the fifth participant device, the sixth participant device, and/or the sixth participant 34.

Where rebates are provided, for example by a utility company, funds may flow back through the network 60, for example to the third participant device 16.

Advantageously, the operation of the present disclosure according to the systems 10, 300 of FIGS. 1, 3 may save the user 304 money. For example, through the second participant device 14 tracking the bill of the third participant device 16, advantageous market rates may be discovered and suggested to the user 304. The second participant device 14 may make market rate-based decisions on behalf of the user 304, for example purchasing additional energy consumption at off-peak usage.

As a further example of saving money, an energy-related resource provided by the fourth participant 28 may be energy-efficient such that less energy as provided by the first participant 22 is used. The system 10 may optimize projects of the third participant 26 based on utility usage and rates. The projects may already be optimized based on utility usage and rates before operation of the system 10.

The foregoing savings may be a source of the funds disbursed to the second participant device 14 from the custodial account 62. The custodial account 62 may disburse a percentage of the savings to the second participant device 14. The custodial account 62 may distribute a fixed fee to the second participant device 14 but may not distribute more funds than the total amount of savings. The fixed fee may be charged a single time, upon enrollment of the third participant device 16 or otherwise, or on a recurring basis, e.g., a monthly basis, corresponding to the modified bill 36 being sent to the third participant device 16 or otherwise. The charges may be scheduled to continue indefinitely, for a finite period of time, for a finite number of payments, or until a total amount paid has been reached or exceeded. A start date may be recorded.

A recurring payment may last for a preset time period. The recurring payment may last until a total amount has been paid to a second payee. The recurring payment may last until an agreed condition is met.

The funds disbursed by the custodial account 62 to the second participant device 14 may be understood as a rebate rather than a fee. The fees charged may be subject to further rebates.

Funds to be paid to the second participant device 14 may remain in the custodial account 62 and may not be transferred to the second participant device 14 directly. The second participant device 14 may create and control the custodial account 62. An external party may control the custodial account.

The second participant device 14 may receive funds from the third participant device 16 and/or the utility and may disburse all or a portion of the funds received to the first participant device 12, the fourth participant device 18, the fifth participant device, and/or the sixth participant device. The second participant device 14 may perform this functionality instead of the custodial account 62. The custodial account 62 may not be present in the network 60.

The custodial account 62 may disburse funds to the EDI vendor 34 separate from disbursements to the second participant device 14. The EDI vendor 34 may be paid from the funds disbursed to the second participant device 14 by the custodial account 62.

The third participant device 16 may pay the modified bill 36 directly to the second participant device 14, and the second participant device 14 may disburse the funds as described above.

In soft enrollment, the second participant device 14 determines there are no known issues preventing enrollment of a customer. The second participant device 14 proceeds by determining whether the customer has a utility account in a region supported by the system 10, whether the customer has a utility account with a utility supported by the system 10, whether the second participant device 14 can look up the customer via the EDI vendor 34 using utility account information provided (which may take up to 2 days), whether the customer has an existing energy retailer (if so, whether the second participant 24 has an existing tri-party agreement in place with that retailer, without which the second participant 24 may approach the retailer about setting up the tri-party agreement) (if not, the second participant 24 may become their energy retailer, and so the customer may successfully be enrolled and supported). If all questions have passed as herein described, the soft enrollment is complete.

The enrollment method may further include an option to cancel enrollment at one or more stages of the enrollment method.

The soft enrollment may include additional regulatory challenges concerning capacity or overall usage. Soft enrollment may include further anti-money laundering requirements of ‘know your business’ and/or ‘know your customer’.

The EDI vendor 34 may be integrated into the soft enrollment method to perform usage checks. There may be manual methods to extract from a utility bill a retailer and account information for EDI integration. Such extraction may be automatic.

A payment API (not shown) of the second participant device 14 may receive an enrollment request of a third participant 26. The request may be received from a utility account of the third participant 26. The payment API may perform a soft enrollment check on the customer to determine whether the customer has a site in a region supported by the system 10 (without which enrollment cannot proceed), whether the customer uses a utility supported by the system 10 (without which enrollment cannot proceed), whether the customer has an existing energy retailer (if so, whether there is an existing tri-party agreement in place with that retailer, without which agreement the second participant 24 approaches the retailer about joining the system 10), and whether the second participant device 14 can successfully perform a request of the EDI vendor 34 for historical usage data of the third participant 26 using account information provided by the third participant device 16 (which request may take up to 2 days to process). The usage data may be provided by the utility.

A participant may be able to connect with the payment API directly to bypass steps otherwise required during registration.

An enrollment request by a third participant 26 or a utility account thereof may be denied for one or more of the following reasons: because an account number was incorrect or incorrectly formatted; because of an outstanding balance to be paid on accounts of the third participant 26; because the third participant 26 already has a supplier or is “pending” in respect of a supplier (in which case the second participant 24 may reach out to and/or add the other supplier in its system to support the particular third participant 26); because the third participant 26 is in a legally protected class (e.g., government-supported payment plan due to low income); because the third participant 26 is located in a region or with a utility not currently supported by the second participant 24; or because of other relevant reasons.

A payment request may be approved or denied. Where the payment request is denied, the denial may not affect enrollment status. Where the payment request is approved, a charge may be added to a database of the second participant 24 including charge information such as the amount, the start date, and a number of payments. The charge information may be forwarded to the EDI vendor 34 to generate the modified bill 36.

Once the transaction is successful, the database may be updated to record a success for any future API calls.

The third participant 26 may be able to contact the second participant 24 and/or log into a portal of the second participant 24 in order to confirm or determine further information as to the modified bill 36.

In hard enrollment, the second participant 24 sends a formal request to become the registered energy retailer for the third participant 26 by sending an enrollment request to the EDI vendor 34. The hard enrollment request may be sent only once a confirmed charge for the third participant 26 exists.

A successful soft or hard enrollment may be required in order for the second participant device 14 to generate the modified bill 36. A utility account may be required to set up a charge on the modified bill 36.

The second participant device 14 may treat all enrollment attempts as soft enrollment.

It may be the case that hard enrollment is invoked only once a confirmed charge for the third participant 26 is obtained. Hard enrollment means that the second participant 24 becomes the energy retailer. The second participant device 14 may pay fees each month to the sixth participant 34. There may be additional risk in paying out electricity costs on behalf of the third participant 26. Because of the foregoing, the second participant 24 may not seek to become the energy retailer until having confirmed that charges will appear on the modified bill 36 and having obtained consent from the third participant 26.

In other embodiments, the second participant may be any entity capable of the above mentioned functions but is not necessarily an “energy retailer”.

In order for another energy retailer to participate in the systems as described above, that retailer may agree to the following: an external party access agreement indicating to an EDI vendor 34 that the second participant device 14 has permission to add charges to a bill “owned” by that retailer; a revenue sharing agreement whereby the second participant 24 may agree to provide a share of payment received from the third participant device 16 to that retailer; an agreement to modify a bank account associated with that retailer, wherein the second participant 24 may ask that retailer to fill out a form changing the registered bank account with that retailer of the third participant 26 to the custodial account 62.

The revenue sharing agreement and/or the agreement to modify the bank account associated with the retailer may be optional.

The payment API may affect soft enrollment of a utility account of the third participant 26 without requiring verbal acknowledgement. Formal enrollment may not occur until a first charge would be added to the modified bill 36.

The network 60 of FIG. 6 may be viewed by each participant 22, 24, 26, 28, 32, 34 on their respective device 12, 14, 16, 18, or the fifth participant device (not shown) or the sixth participant device (not shown) through a portal (not shown). Each participant device may be able to confirm the flow of funds they have paid or are to be paid by seeing where, when, and how the funds are moved. The third participant device 16 may be shown a detailed breakdown of charges placed on the modified bill 36, savings, costs for each of the energy and the energy-related resource, etc. The first participant 22 and the fourth participant 28 may see that the custodial account 62 has collected payment from the third participant device 16 and disbursed agreed amounts to each of the first participant device 12 and the fourth participant device 18.

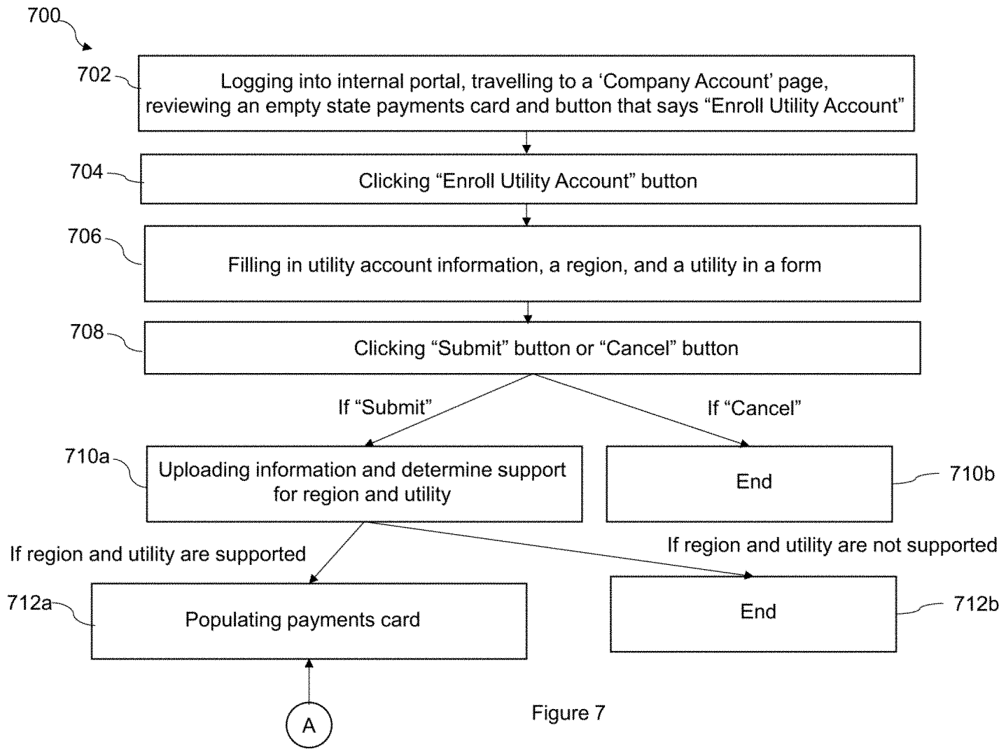

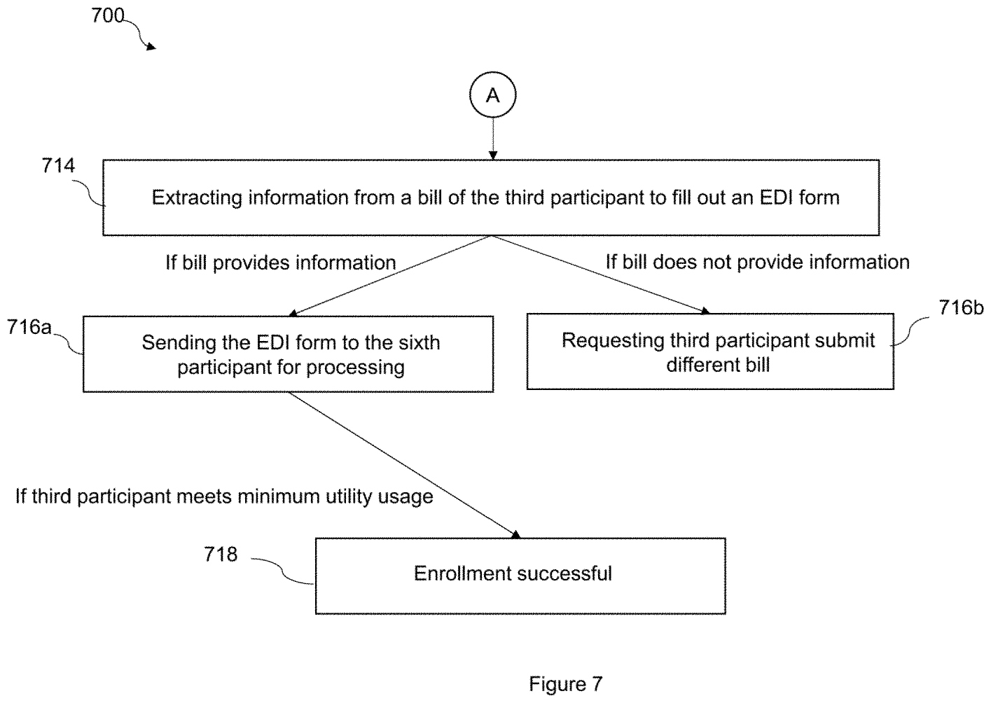

Referring now to FIG. 7, shown therein is a flow diagram of a method 700 for soft enrollment of a third participant 26, in accordance with an embodiment.

The method includes 702, logging into an internal portal of the second participant 24, travelling to a ‘Company Account’ page, and reviewing an empty state payments card and button that says “Enroll Utility Account”.

At 704, indicating to enroll a utility account of the third participant by clicking the button. Given a company account is already set up, a form may appear to be filled in with a utility account address, a region, a country, a state or province, a postal code, and a utility.

At 706, filling in at least utility account information, a region, and a utility in the form.

At 708, there may further be a ‘submit’ button to submit the foregoing information and a ‘cancel’ button to cancel the entire enrollment method.

At 710a, if the ‘submit’ information is selected, uploading information and determine support for region and utility.

At 710b, if the ‘cancel’ button is selected, the method ends.

At 712b, if the region or utility is not supported, the method ends. The second participant device 14 may be notified of the reasons for ending the method.

At 712a, once the bill and utility account address have been successfully uploaded and once it is determined that the utility account is in a region supported by the second participant 24 and the utility is supported by the second participant 24, populating a payments card associated with the third participant 26. Populating the payments card may proceed according to utility account ID, a date added, a date edited, a status, a status code, and a notification that enrollment is in progress. The notification may be clickable.

At 714, extracting information from a bill of the third participant 26 to fill out an EDI form of the sixth participant. Information of the third participant 26, such as an account number, identity of a utility, and physical address of the third participant 26 may be required for enrollment to successfully complete. OCR may be used to determine required information from a bill. This information may be verified, reviewed, and/or used to fill out a form, automatically and/or manually, before the internal portal of the second participant 24 calls a payment API of the second participant 24 to enroll the third participant 26. The information used to fill out the form may include an account number, an account type, a utility account identifier, an external ID, a full name of a customer, a service postal code., and an action, e.g., a request to enroll. The same EDI transaction may refer to “dropping” the third participant 26, i.e., removing the third participant 26 as a customer of the energy retailer.

At 716a, if the bill provides the requisite information, sending the EDI form to the sixth participant 34 by clicking ‘submit’.

At 716b, if the bill does not provide the requisite information, requesting the third participant device 16 or the first participant device 12 submit a different bill. The second participant device 14 may be informed that a different bill is required. The second participant device 14 may further request the different bill from the third participant device 16 or the first participant device 12.

The first participant device 12 and/or the third participant device 16 may be able to upload the bill through the portal in order to make it available. If the bill is inadequate or insufficient for enrollment (e.g., information unclear or missing), the system 10 may notify the first participant device 12 and/or the third participant device 16 that a further bill is required for enrollment. A utility account of the third participant 26 and/or utility account address may be further required in addition to a bill. When the bill is resubmitted, a clickable ‘enrollment’ notification may be provided to return to the appropriate step of the enrollment method.

If the EDI vendor 34 takes longer than expected (e.g., exceeds the 2 days), the second participant 24 may contact the EDI vendor 34.

At 718, if the third participant 26 meets the minimum utility usage, then soft enrollment has been successful. The EDI vendor 34 may determine the utility usage of the third participant 26 and provide that information. The usage data may be provided by the utility.

If the third participant 26 does not meet the minimum utility usage, the second participant device 14 may be informed that the soft enrollment has failed.

Once a third participant 26 is successfully enrolled, in the system 10, the second participant device 14 may be informed that the third participant device 16 is able to participate in payments and is ready for a first charge to be placed on the modified bill 36. The EDI vendor 34 may provide utility account usage information of the utility account of the third participant 26 to the second participant device 14. Successful enrollment may mean that information sent to the EDI vendor 34 is processed and the utility account's usage is above a minimum value, e.g., 200 MWh. Once the third participant 26 is successfully enrolled in the system 10, a payment details page may be available.

The method 700 may be performed by the second participant 24. The fourth participant 18 may log into the portal to make the request or send an API request to perform a similar action.

Enrollment may support five statuses. One such status is ‘active’, wherein a customer has agreed to be a part of payments and is actively a part (i.e., charges have happened and continue to happen or a charge is planned in the future). An ‘active’ status may indicate successful hard enrollment. A further such status is ‘pending’, wherein enrollment has been requested but customer verbal approval is necessary, or the second participant 24 awaits confirmation from the utility, or the second participant 24 has confirmed that a customer is supported and awaits a subsequent charge to be added to the system 10. A further such status is ‘declined’, wherein a customer has declined to be a part of payments. A further such status is ‘inactive’, wherein a customer was a part of payments in the past but no longer wishes to be or has been removed by the second participant 24. A further such status is ‘unsupported’, wherein the customer is located in a region or with a utility currently unsupported by the second participant 24. Each status may be given a code for providing further context to the status. For example, a pending state may be assigned a code indicating that the second participant 24 is awaiting customer confirmation or utility confirmation.

‘Pending’ may be a default status for all new enrollments. Enrollment may await approval from the second participant 24, the customer, and/or an external party.

A status may be set to ‘pending’ whenever updates to the enrollment or information thereon are made, subject to review by the second participant 24 and delaying any associated charges. It may not be possible to edit an enrollment if a charge associated to the customer account has a status of ‘failed’.

Enrolling a customer may involve the customer providing a total amount of money agreed to be added to bills, a number of payments (e.g., one for a one-time charge), and a monthly charge (if one time, then the total amount, and if recurring, the total amount divided by the number of payments).

Upon successful completion of enrollment, the internal portal of the second participant 24 may be informed that enrollment is successfully completed. The internal portal may further be informed when the third participant 26 approves the charge that the second participant 24 seeks to place on the modified bill 36.

A charge may have a status as follows. One such status is ‘succeeded’, wherein payment was completed successfully. A further such status is ‘pending’, wherein a charge is waiting on an external party, on the second participant 24, or customer approval. A further such status is ‘failed’, wherein an error has occurred. A further such status is ‘inactive’, wherein a charge has been halted at the request of the customer, the utility, or the second participant 24, or a recurring charge has been paused. Each charge may be given a code for providing further context to the status.

‘Pending’ may be a default status of new charges. ‘Pending’ indicates that a charge is awaiting confirmation to be finalized, e.g., awaiting customer or utility approval.

As an example, the second participant device 14 may charge fees of 3% of the total charge per transaction, to be charged when a transaction has been successfully applied. There may be no further fees charged (e.g., no setup fees, no monthly fees, and no hidden fees).

The second participant device 14 may assume that any charges placed through the payment API subject to taxation in the relevant jurisdiction(s) have had the appropriate tax amount already added thereto. The second participant device 14 may not increase the charge (or rebate) to compensate for taxes and may not collect tax on behalf of any government or governmental organization.

Customers may be required to pay the modified bill 36 in the currency of the region (e.g., CAD in Canada, USD in the United States).

It may be possible for part or all of a charge to be refunded to a customer as necessary. A successful enrollment and charge may be required to set up a refund. It may not be possible to edit refunds once created. Changes to a refund may only be possible through the second participant device 14. A refund may only be available for amounts paid other than any fees earned by the second participant device 14 (i.e., only for funds disbursed by the custodial account 62 other than to the second participant device 14).

A charge may be associated with multiple refunds.

It may not be possible to edit a charge once created except through the second participant device 14.

A refund may have a status as follows. One such status is ‘pending’, which is a default status for new refunds, indicating the refund is awaiting confirmation to be finalized and processed. A further such status is ‘approved’, indicating the refund has been approved and is pending being placed on a subsequent utility bill. A further such status is ‘succeeded’, indicating the refund has been placed on the subsequent utility bill. A further such status is ‘failed’, indicating the refund did not go through due to an error or was not approved.

Each refund may be given a code for providing further context to the status.

Refunds may only be allowed for certain reasons, e.g., to correct a duplicate charge placed on a modified bill 36 out of error, when requested by a customer and granted, when requested by an external party associated with the second participant device 14 and granted.

The second participant device 14 may prepare a new bill and may include charges of the first participant device 12 and the fourth participant device 18 on the new bill of the second participant device 14 rather than adding charges to the bill of the first participant device 12. The second participant device 14 may send the new bill to the third participant device 16 for payment.

The second participant device 14 may send further separate written statements, explanations, and/or “breakdowns” of the modified bill 36 to the third participant device 16 before, during, or after sending the modified bill 36 to the third participant device 16. The “breakdowns” may include an overview of savings and costs incurred by the third participant 26. As some jurisdictions limit what may be added to bills, explanations for charges may appear separately.

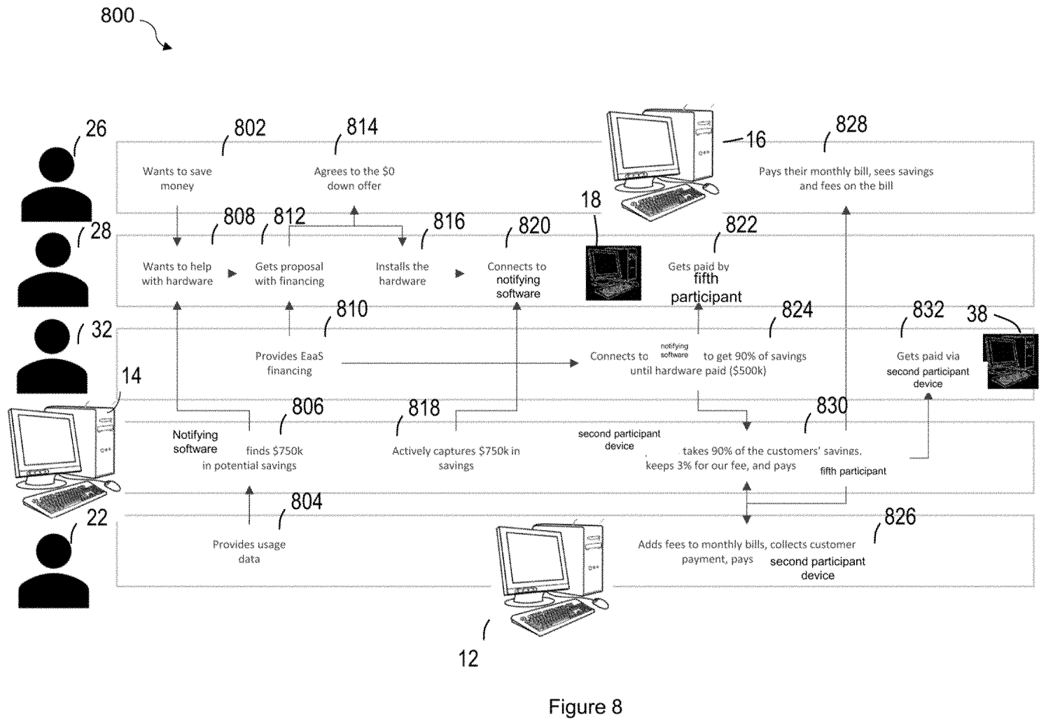

Referring now to FIG. 8, shown therein is a view 800 of the structure of system 10 in operation, in accordance with an embodiment.

At 802, the third participant 26 wants to save money.

At 804, the first participant 22 (here a utility) provides usage data to the second participant device 14.

At 806, notifying software of the second participant device 14 finds an available amount of potential savings for the third participant 26. The available amount shown in the view 800 is $750,000. The savings would be available to the third participant 26 if the third participant 26 made use of an energy-related resource offered by the fourth participant 28.

At 808, the fourth participant 28 wants to provide an energy-related resource to the third participant 26.

At 810, the fifth participant 32 provides efficiency as a service (EaaS) financing as a proposal to the fourth participant 28.

At 812, the fourth participant 28 receives the EaaS proposal from the fifth participant 32.

At 814, the third participant 26 agrees to an offer from the fourth participant 28. The offer may include $0 down as shown in the view 800.

At 816, after the third participant 26 has agreed to the offer, the fourth participant 28 installs the energy-related resource with the third participant 26.

At 818, the second participant device 14 actively captures the $750,000 in savings. The second participant device 14 allows the third participant 26 to avoid using electricity when the electricity would be provided at a very high cost. Accordingly, savings of $750,000 may be generated over time, e.g., over 1-2 years.

At 820, the fourth participant 28 connects to the notifying software for notifying the energy-related resource when electricity will be provided at a very high cost to inform the fourth participant 28 to use the energy-related resource to avoid using the high-cost electricity.

At 822, the fourth participant device 18 is paid by the fifth participant 32.

At 824, the fifth participant 32 connects to the software for notifying to receive 90% of the savings until the energy-related resource is paid for. As shown in the view 800, the energy-related resource may cost $500,000.

At 826, the first participant device 12 adds the second participant fees to monthly bills, collects payment from the third participant device 16, and pays the second participant device 14. Advantageously, there may be a lower charge for electricity on the modified bill. The second participant device 14 is paid a percentage of the savings resulting therefrom.

At 828, the third participant device 16 pays the modified bill 36, seeing savings and the second participant fees displayed on the modified bill 36. As shown in the view 800, the modified bill 36 may be delivered to the third participant device 16 on a monthly basis.

At 830, the second participant device 14 takes 90% of the savings, retains 3% as second participant fees, and pays the remainder to the fifth participant 32. At 832, a fifth participant device 38 is paid from the second participant device 14.

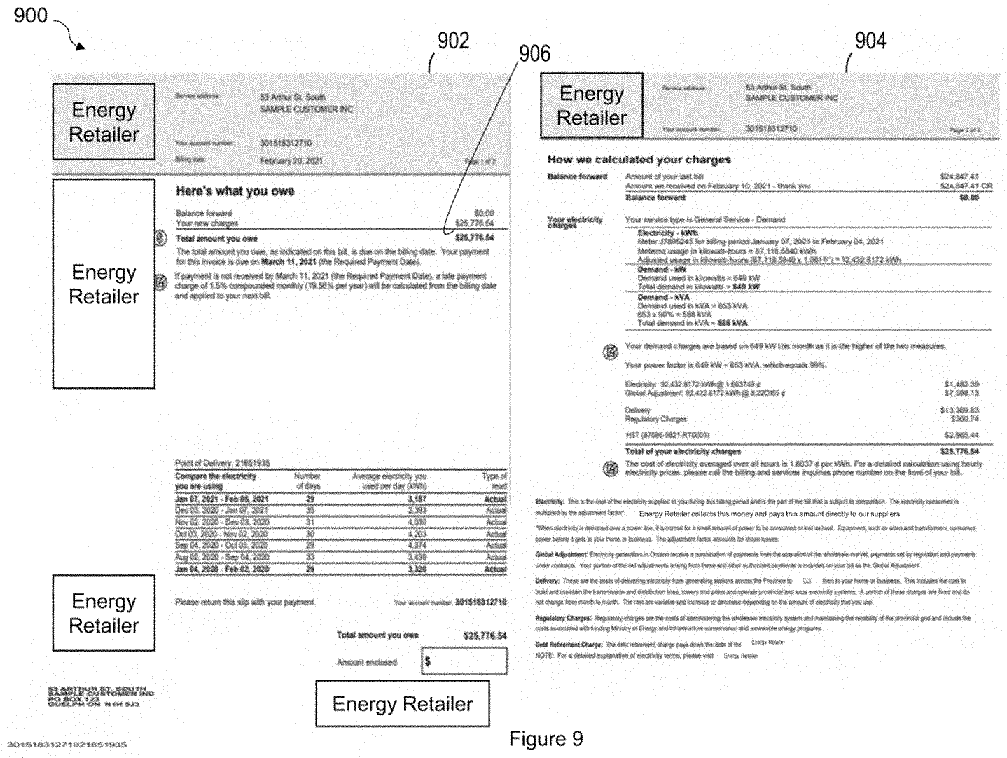

Referring now to FIG. 9, shown therein is an exemplary bill 900 as provided to the system 10, in accordance with an embodiment. The bill 900 may be a bill before modification.

The bill 900 includes a first page 902 and a second page 904.

The first page 902 includes charges 906.

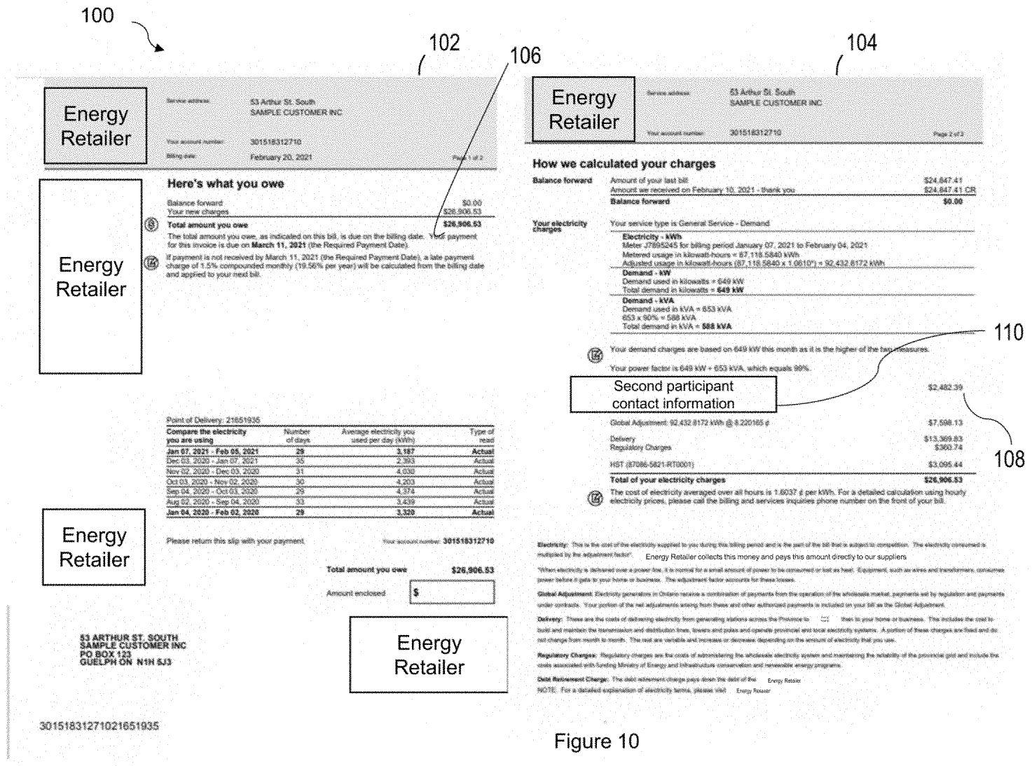

Referring now to FIG. 10, shown therein is an exemplary bill 100 as provided by the system 10, in accordance with an embodiment.

The bill 100 includes a first page 102 and a second page 104.

The first page 102 includes charges 106.

The second page 104 includes second participant fees 108.

The second page 104 includes second participant information 110 for contacting the second participant 24 for further information on the bill 100.

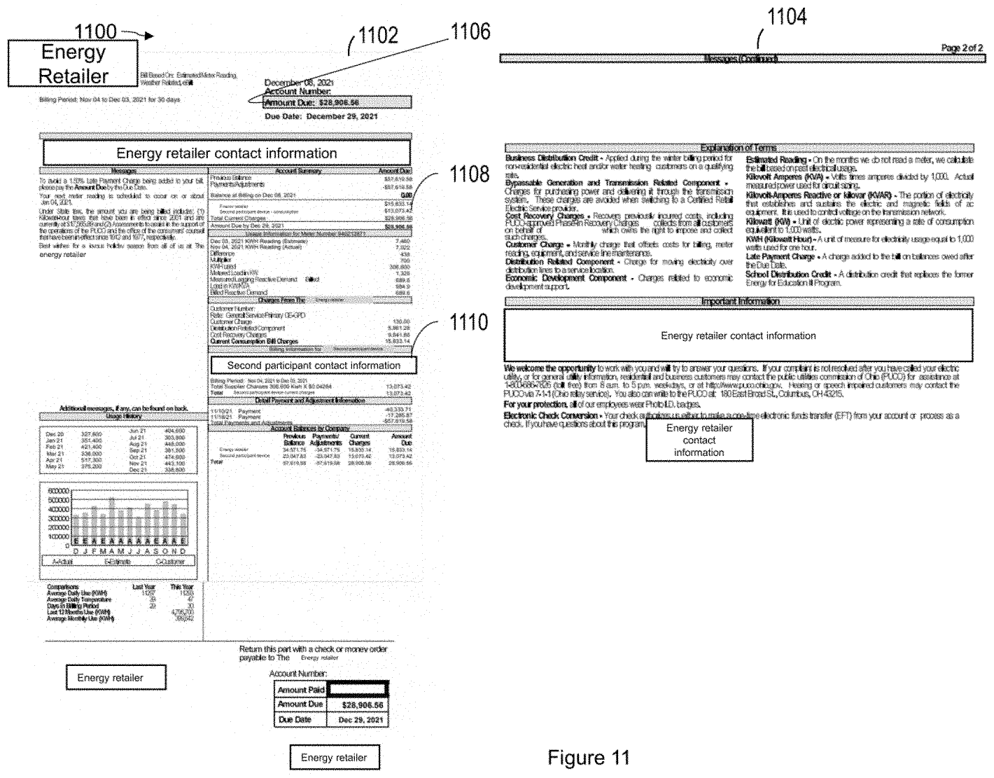

Referring now to FIG. 11, shown therein is an exemplary bill 1100 as provided by the system 10, in accordance with an embodiment. The bill 1100 may be a modified bill 36.

The bill 1100 includes a first page 1102 and a second page 1104.

The first page 1102 includes charges 1106.

The first page 1102 further includes second participant fees 1108.

The first page 1102 further includes second participant information 1110.

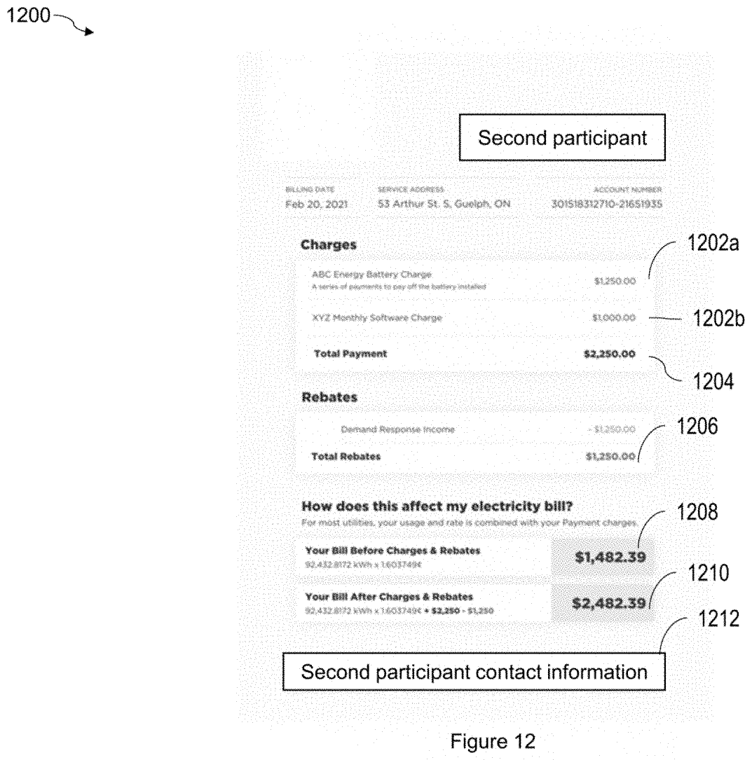

Referring to FIG. 12, shown therein is an exemplary account statement 1200, in accordance with an embodiment.

The account statement includes charges 1202a, 1202b in respect of second resources. The charge 1202a corresponds to a first second resource (here indicated as provided by ABC Energy Battery). The charge 1202b corresponds to a second second resource (here indicated as provided by XYZ Monthly Software). The statement 1200 indicates that the charge 1202a is a series of payments to pay off the battery installed.

The charges 1202a, 1202b are summed up as a total charge 1204 provided on the statement 1200.

The statement 1200 further includes a rebate 1206 to be counted against the total charge 1204.

The statement 1200 further includes a subtotal 1208 calculated before the total charge 1204 is added and before the rebate 1206 is subtracted. The subtotal 1208 may represent actual usage of a first resource, such as electricity.

The statement 1200 further includes a total 1210 calculated after the total charge 1204 is added and before the rebate 1206 is subtracted. The total 1210 is the amount due for payment.

The statement 1200 further includes second participant contact information 1212. A third participant 26 may contact the second participant 24 via the second participant contact information 1212, for example to inquire about the statement 1200.

While the above description provides examples of one or more apparatus, methods, or systems, it will be appreciated that other apparatus, methods, or systems may be within the scope of the claims as interpreted by one of skill in the art.

1. A system for automating billing and payments, the system comprising:
an energy generation device of a first participant for providing energy to a third participant;
a device of the first participant for sending a bill to a device of a second participant for the energy provided by the energy generation device to the third participant;
the device of the second participant for receiving the bill from the device of the first participant, modifying the bill according to energy-related resource billing data provided by a device of a fourth participant by adding the fourth participant to the bill as a second payee, and sending the modified bill to a device of the third participant;
the third participant for receiving the energy from the first participant and an energy-related resource from the fourth participant;
the device of the third participant for receiving the modified bill from the device of the second participant and paying the modified bill;
the fourth participant for providing the energy-related resource to the third participant; and
the device of the fourth participant for sending the energy-related resource billing data for the energy-related resource to the device of the second participant.

2. The system of claim 1, wherein the modified bill comprises a one-time payment to the second payee.

3. The system of claim 1, wherein the modified bill comprises a recurring payment to the second payee.

4. The system of claim 1, wherein the modified bill comprises a one-time payment to the second payee and a recurring payment to the second payee.

5. The system of claim 3, wherein the recurring payment lasts for a preset time period.

6. The system of claim 3, wherein the recurring payment lasts until a total amount has been paid to the second payee.

7. The system of claim 3, wherein the recurring payment lasts until an agreed condition is met.

8. The system of claim 1, wherein the first participant is an energy retailer with a legally protected status with respect to the third participant, and the status is not affected by the operation of the system, and a soft enrollment check of the third participant is performed before the bill is sent by the device of the first participant.

9. The system of claim 1, wherein the first participant is an energy utility, the second participant assumes the legally protected status of a power retailer with respect to the third participant, and a hard enrollment check of the third participant is performed before the bill is sent by the device of the first participant.

10. A method for automating billing and payments, the method comprising:
providing energy;
preparing a bill for the energy;
a fourth participant providing an energy-related resource;
preparing energy-related resource billing data for the energy-related resource, the energy-related resource billing data comprising a second payee;
modifying the bill according to the energy-related resource billing data by adding the fourth participant to the bill as the second payee;
sending the modified bill; and
paying the modified bill.

11. The method of claim 10, wherein the energy is electricity and the energy-related resource is hardware resources.

12. The method of claim 10, further comprising paying the modified bill by making a payment.

13. The method of claim 12 further comprising a fifth participant providing financial services in respect of the bill, the first billing data, or the modified bill.

14. The method of claim 13 further comprising a sixth participant providing EDI services to modify the bill.

15. The method of claim 14, further comprising an initial step of executing a tri-party agreement among a first participant providing the energy, a second participant, and the sixth participant to modify the bill according to the first billing data provided by the device of the fourth participant by adding the fourth participant to the bill as the second payee, the tri-party agreement comprising an agreement to allow the device of the second participant to instruct the sixth participant to modify the bill according to the first billing data provided by the device of the fourth participant by adding the fourth participant to the bill as the second payee, an agreement to share revenue of the device of the second participant received from a device of a third participant receiving the energy with the device of the first participant, and an agreement to modify a bank account associated with the device of the first participant into a custodial account.

16. The method of claim 14, wherein a device of a second participant modifies the bill with the first billing data by adding the fourth participant to the bill as the second payee and charges second participant fees, and wherein the second participant fees comprise a fixed amount and/or a percentage of the payment.

17. The method of claim 16, wherein the device of the second participant calculates an amount saved by the device of the third participant relative to what the device of the third participant would have paid the device of the first participant, and the custodial account disburses a portion of the amount saved to a device of the second participant.

18. The method of claim 16, wherein paying the modified bill comprises paying the device of the first participant a payment, the device of the first participant deducting an amount for the energy, and paying a remainder of the payment to the custodial account.

19. The method of claim 14, further comprising performing a hard enrollment check, the hard enrollment check comprising sending a formal request to become the energy retailer in respect of the third participant to the sixth participant, the hard enrollment check being performed after a confirmed charge for the device of the third participant is obtained.

20. A device of a second participant for automating billing and payments, the device of the second participant comprising:
a receiving module for receiving a bill from a device of a first participant and energy-related resource billing data from a device of a fourth participant, the bill corresponding to energy provided by the first participant, and the energy-related resource billing data corresponding to an energy-related resource provided by the fourth participant;
a modifying module for modifying the bill according to the energy-related resource billing data by adding the fourth participant to the bill as a second payee; and
a collection module for sending the modified bill to a device of a third participant for payment.
